(19) United States
(12) Patent Application Publication
(10) Pub. No.: US 2016/0117778 A1
(43) Pub. Date: Apr. 28, 2016

(54) Systems and Methods for Computerized Fraud Detection Using Machine Learning and Network Analysis

(71) Applicant: Insurance Services Office, Inc., Jersey City, NJ (US)

(72) Inventors: Tamara Costello, Richmond, VA (US); Krassimir G. Ianakiev, San Francisco, CA (US); Janine Johnson, Castro Valley, CA (US)

(73) Assignee: Insurance Services Office, Inc., Jersey City, NJ (US)

(21) Appl. No.: 14/921,773

(22) Filed: Oct. 23, 2015

Related U.S. Application Data
(60) Provisional application No. 62/067,792, filed on Oct. 23, 2014.

(51) Int. Cl. G06Q 40/08; G06N 99/00

(52) U.S. Cl. CPC G06Q 40/08; G06N 99/005

(57) ABSTRACT

Systems and methods for computerized fraud detection using machine learning and network analysis are provided. The system includes a fraud detection computer system that executes a machine learning, network detection engine/module for detecting and visualizing insurance fraud using network analysis techniques. The system electronically obtains raw insurance claims data from a data source such as an insurance claims database, resolves entities and events that exist in the raw claims data, and automatically detects and identify relationships between such entities and events using machine learning and network analysis, thereby creating one or more networks for visualization. The networks are then scored, and the entire network visualization, including associated scores, are displayed to the user in a convenient, easy-to-navigate fraud analytics user interface on the user's local computer system.

### RELATED Applications

This application claims priority to U.S. Provisional Application Ser. No. 62/067,792 filed Oct. 23, 2014, which is expressly incorporated herein by reference in its entirety.

### BACKGROUND

1. Field of the Invention

The present invention relates to improvements in computing systems utilized in the insurance- and risk-related industries. More specifically, the present invention relates to systems and methods for computerized fraud detection using machine learning and network analysis.

2. Related Art

In the insurance industry, detection of fraudulent activities is an extremely important issue. Fraudulent insurance practices, particularly organized insurance fraud occurring across different geographic locations (e.g., in multiple states) are not only severe crimes, but they also represent undue burden and expense to insurers. Organized insurance fraud has a greater risk of repeat fraudulent activity, and also results in significantly greater financial exposure to insurers than opportunistic fraud. Also, perpetrators of organized insurance fraud often employ sophisticated techniques for eluding traditional methods of detecting fraud. As such, there is a significant need to detect wide-spread fraud in the insurance industry, particularly organized insurance fraud.

In the fields of mathematics and computer science, graph theory is an important technique for studying the relationships between entities (nodes), as well as networks formed by such entities and relationships. Typically, a graph is a network of nodes and lines called “edges” which connect the nodes. A graph can be undirected, in that there is no distinction between two nodes associated with an edge, or directed, in that nodes are connected by edges in specific directions. Graphs (networks) can be used to model many types of relationships and processes in the physical world, in biology, and other fields of endeavor such as social and information systems.

Of particular interest to those in the insurance and risk-related industries, and as discussed in detail herein, graph theory and network analysis can be powerful tools for detecting and analyzing fraudulent insurance activity, particularly organized insurance fraud. Accordingly, the present disclosure addresses these and other needs.

### SUMMARY

The present disclosure relates to systems and methods for computerized fraud detection using machine learning and network analysis. The system includes a fraud detection computer system that executes a machine learning, network detection engine/module for detecting and visualizing insurance fraud using network analysis techniques. The system electronically obtains raw insurance claims data from a data source such as an insurance claims database. The raw insurance claims data is processed by the network detection engine/module to resolve entities and events that exist in the raw claims data. Once the entities and events have been resolved, the system electronically processes the resolved entities and events using network analysis techniques to detect and identify relationships between such entities and events, thereby creating one or more networks for visualization. The networks are then scored by the engine using one or more models, and the entire network visualization, including associated scores, are displayed to the user in a convenient, easy-to-navigate fraud analytics user interface on the user's local computer system. The system provides a significant advance in computing technology by allowing existing computers to perform sophisticated fraud detection techniques which such computers would not ordinarily be able to perform.

### BRIEF DESCRIPTION OF THE DRAWINGS

The foregoing features of the invention will be apparent from the following Detailed Description, taken in connection with the accompanying drawings, in which:

FIG. 1 is a diagram illustrating a system in accordance with the present disclosure for fraud detection using network analysis;

FIG. 2 is diagram illustrating software modules of the network detection engine/module of FIG. 1;

FIG. 3 is a high-level flowchart illustrating processing steps carried out by the network detection engine/module of FIG. 1;

FIG. 4 is a flowchart illustrating step 44 of FIG. 3 in greater detail;

FIG. 5 is a flowchart illustrating step 72 of FIG. 4 in greater detail;

FIG. 6 is flowchart illustrating step 44 of FIG. 3 in greater detail;

FIG. 7 is a flowchart illustrating step 46 of FIG. 3 in greater detail;

FIG. 8 is a flowchart illustrating step 134 of FIG. 7 in greater detail;

FIG. 9 is a flowchart illustrating step 48 of FIG. 3 in greater detail;

FIG. 10 is a table illustrating event resolution processing performed by the system;

FIG. 11 is a diagram illustrating a network visualization generated by the system for detecting and visualizing fraud; and

FIGS. 12-13 are screenshots illustrating the user interface generated by the system, including a network visualization generated by the system.

### DETAILED DESCRIPTION

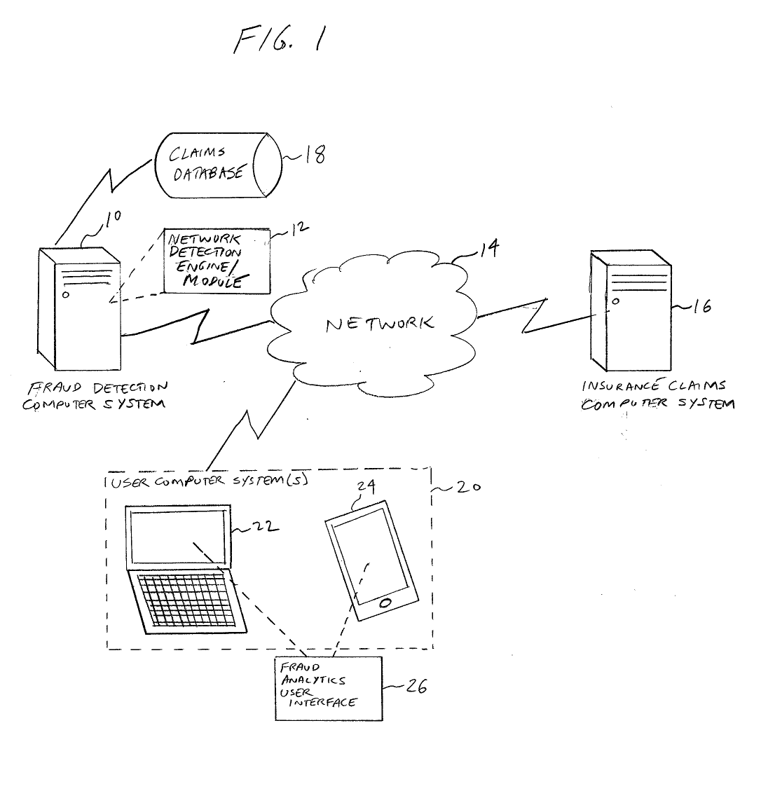

The present disclosure relates to a system and method for computerized fraud detection using machine learning and network analysis, as described in detail below in connection with FIGS. 1-13.

FIG. 1 is a diagram illustrating a system in accordance with the present disclosure for fraud detection using network analysis. The system includes a fraud detection computer system 10 which is a specially-programmed computer system that stores and executes a machine learning, artificially intelligent, network detection engine/module 12. The fraud detection computer system 10 could include a computer system such as a server, a network of servers (e.g., a server farm, server cluster, etc.), or any other desired computer system having one or more microprocessors (e.g., one or more microprocessors manufactured by INTEL, Inc.) and executing a suitable operating system such as UNIX, LINUX, etc. Importantly, the network detection engine/module 12 comprises specially-programmed software code which, when executed by the computer system 10, causes the computer system to perform fraud detection and visualization functions described in detail below, using machine learning techniques. As described in detail below, such functions allow for precise and rapid automatic detection and visualization of potentially fraudulent activities such as organized insurance fraud, etc., but it is noted that the system could also be used to detect other activities across large data sets, such as underwriting fraud and other activities. The network detection engine/module 12 could be programmed in one or more suitable high-level computer programming languages such as C, C++, C#, Java, Python, Ruby, Go, etc. Of course, it is noted that any other suitable programming language could be utilized without departing from the spirit or scope of the present invention.

The network detection engine/module 12 can optionally communicate over a network 14 with one or more insurance claims computer systems 16 to obtain and process digital information relating to insurance claims. Alternatively, or additionally, such information could be stored in an insurance claims database 18 which could be stored on the fraud detection computer system 10 and hosted using a suitable relational database management system (DBMS) such as that manufactured by ORACLE, Inc. or any other equivalent DBMS. The insurance claims database 18 could also include other relevant information such as payments made by insurers on claims, etc. Of course, the database 18 could be stored on another computer system in communication with the computer system 10, if desired. The network 14 could include any suitable digital communications network such as the Internet, an intranet, a wide area network (WAN), a local area network (LAN), a wireless network, cellular data network(s), or any other suitable type of communications network. As can be appreciated by one of ordinary skill in the art, suitable network security equipment and/or software could be provided to secure both the fraud detection computer system 10 and the insurance claims computer system 16, such as routers, firewalls, etc.

One or more user computer systems 20, such as a laptop 22, a smart cellular telephone (such as an IPHONE, an ANDROID phone, etc.), a personal computer, a tablet computer, etc., could communicate with the fraud detection computer system 10 via the network 14. The fraud detection computer system 10 generates a web-based fraud analytics user interface 26 which is displayed by the computer system(s) 20 and which allows a user of the computer system(s) 20 to conduct detailed analysis, detection, and visualization of fraud that may exist in the claims database 18 utilizing the user interface 26. Advantageously, as discussed in detail below, the engine/module 12 conducts network analysis on data in the claims database 18 to detect potential fraud, and quickly and conveniently illustrates such potential fraud using one or more network visualizations that are displayed in the user interface 26 and can be quickly and conveniently accessed by a user of the computer system(s) 20.

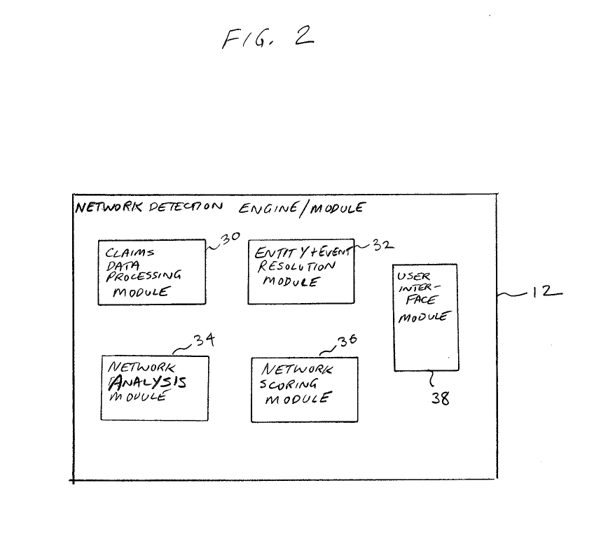

FIG. 2 is diagram illustrating various software modules of the network detection engine/module 12 of FIG. 1. The network detection engine/module 12 is a machine learning module that includes a plurality of software modules 30-38 which perform various functions. It includes a claims data processing module 30, an entity and event resolution module 32, a network analysis module 34, a network scoring module 36, and a user interface module 38. Together, these customized modules, when executed by the computer system 10, cause the computer system to automatically learn relationships (using machine learning techniques) between potentially massive quantities of insurance data, and to automatically identify potentially fraudulent activities and to visualize the identified relationships and identities using a customized visualization user interface. With use, the module 12 automatically improves its own performance through machine learning techniques, including, but not limited to, the network detection and scoring features discussed herein. The modules thus significantly improve the functioning of the computer system 10 by allowing the system 10 to rapidly and dynamically detect and visualize potential insurance fraud for users of the system, in a way that computer systems could heretofore not perform such functions.

Turning to the specific modules, the claims data processing module 30 electronically receives and processes raw claims data from, for example, the claims database 18 of FIG. 1. Functions performed by the module 30 include, but are not limited to, optionally removing (cleansing) personal information from the data, formatting the data into a common data storage (table) format, etc. The entity and event resolution module 32 processes output data from the claims processing module 30 to resolve both entities within the data (e.g., the identities of individuals, claimants, policy holders, insurers, service providers (e.g., healthcare service providers, etc.), employers, etc.) as well as events (e.g., insurance claim events, medical claims/procedures, legal actions, etc.).

The network analysis module 34 processes output from the entity and event resolution module 32 to automatically generate one or more networks linking entities and events identified by the entity and event resolution module 32. The network scoring module 36 scores each network generated by the network detection module 34, so as to provide an indication of the degree of fraud occurring within the network. Importantly, the modules 34 and 36, by automatically generating networks from the ingested data and scoring those networks, cause the computer system 10 to automatically learn relationships between insurance data and to automatically detect and visualize potentially fraudulent activities. They therefore constitute significant machine learning (artificial intelligence) modules that cause the computer system to perform functions that it could not perform before, thereby significantly improving the functioning of the computer system 10. As such, the computer system 10, when programmed to execute the modules discussed herein, becomes a particular machine capable of performing advanced, automated fraud detection and visualization techniques not heretofore provided. Indeed, as discussed below, the processes executed by the network detection and scoring modules 34 and 36 improve their own functionality and ability to detect fraudulent activity through feedback techniques (e.g., by automatically adjusting and improving the scoring functions performed by the system, with subsequent use of the system).

The user interface module 38 generates a computer user interface, discussed below, which displays a visualization of the network(s) generated by the network detection module 34 and provides other useful information. As will be discussed in greater detail below, the network visualization generated by the system allows a user of the system to quickly and conveniently detect potentially fraudulent insurance-related activities.

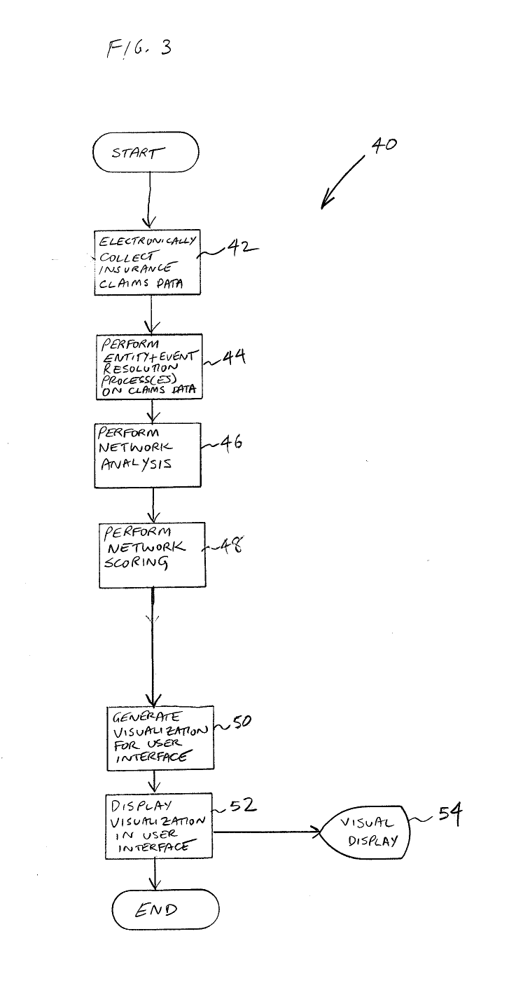

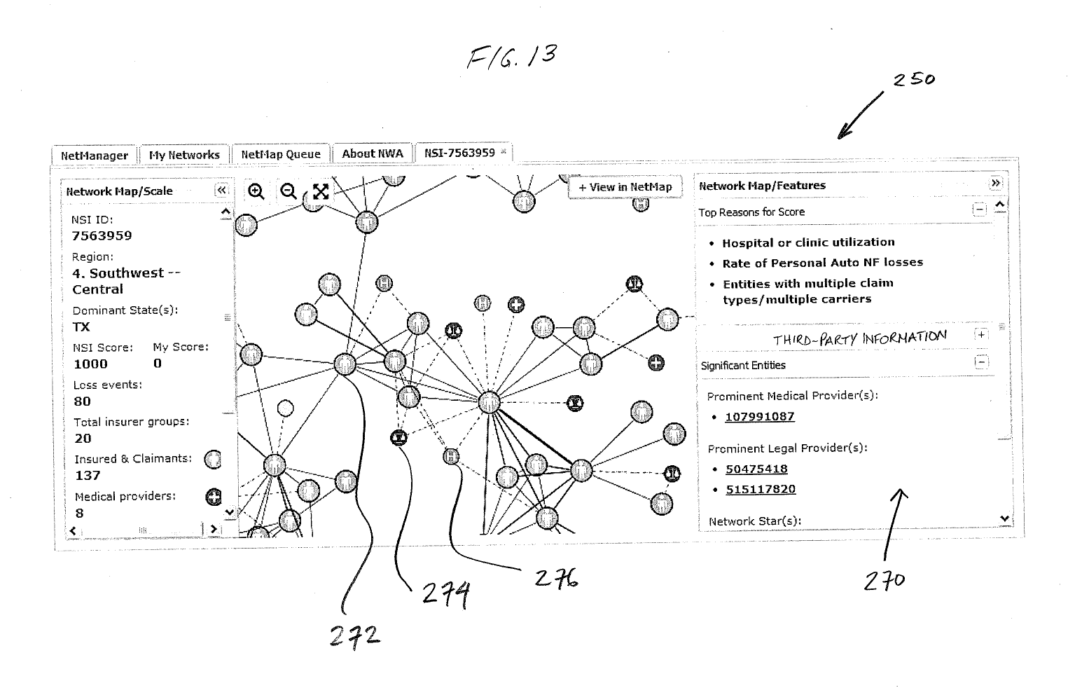

FIG. 3 is a flowchart showing processing steps, indicated generally at 40, carried out by the network detection engine/module 12 of FIG. 1. Beginning in step 42, the system electronically collects insurance claims data from a data source, such as from the claims database 18 of FIG. 1. In step 44, the system performs entity and event resolution processes on the claims data in order to resolve entities (e.g., persons, legal entities, insurance claimants, healthcare providers, legal service providers, etc.) and events (e.g., insurance claims, medical claims, legal actions, etc.) from the raw claims data. Then, in step 46, the system performs network analysis on the revolved entities and events. Importantly, as will be discussed in greater detail below, such network analysis permits a user of the system to identify connections (links) between events and entities, and to discover potentially fraudulent activities. In step 48, the system performs network scoring by scoring the links established between the entities and events by the network analysis performed in step 46. As discussed in greater detail below, the network scoring performed in step 48 could be carried out using one or more predictive computer models (supervised and/or unsupervised) which are applied by the system to the networks identified by the system, and specifically, to variables which are associated with the networks and automatically identified by the system. These network variables are scored by the predictive computer models to provide indications of fraud-related risk, which can be visualized by the system as discussed below. Then, in step 50, the system generates a graphical network visualization for display in the user's interface, as illustrated in FIGS. 13-14 and described in greater detail below. Then, in step 52, the visualization is displayed on a visual display 54 of the user's computer device (e.g., on the computing device(s) 20 of FIG. 1). The user can then view and interact with the visualization to discover potential network fraud and to conduct various analytics, as desired. It is noted that the network visualizations generated by the system can be generated upon request from the user of the system (“pull” delivery) or, they could be programmed to happen automatically (“push” delivery).

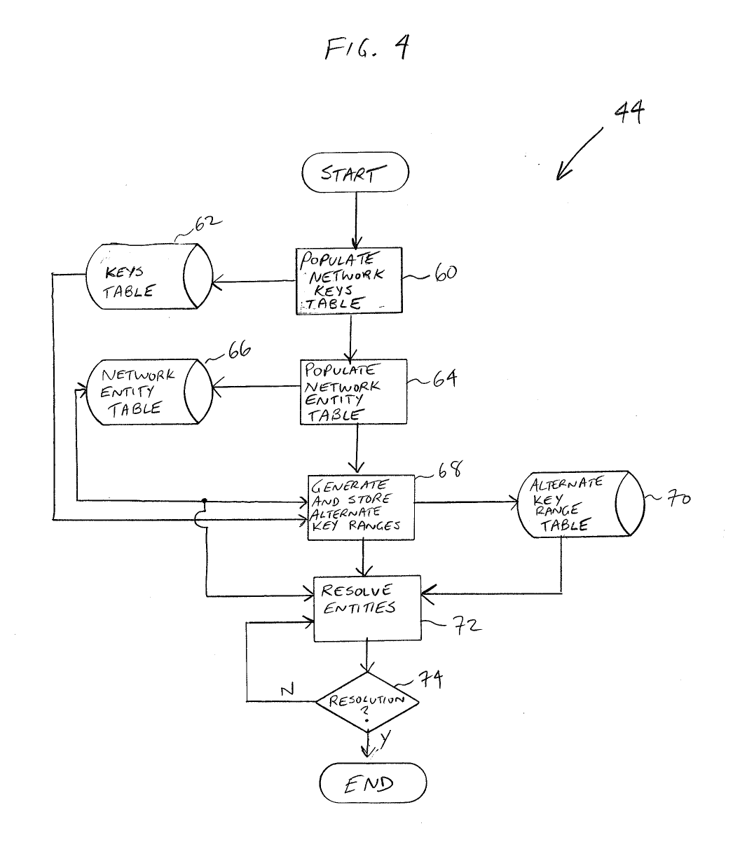

FIG. 4 is a flowchart showing step 44 of FIG. 3 in greater detail. The steps shown in FIG. 4 illustrate how the system resolves entities from the raw claims data using “keys.” In step 60, the system populates a “keys” database table 42 with network keys. By the term “keys” it is meant data which represents individuals (e.g., individual insureds) and which facilitates searching and matching functions performed by the system. Examples of such keys include, but are not limited to, primary keys (keys which are used to perform database/table queries), range keys (keys which represent ranges of values, such as ranges of names, etc.), and/or alternate keys (keys which represent other types of information). Then, in step 64, the system populates a network entity table 66 with primary keys for all identities, including business keys, address keys, primary key ranges, and other metadata. In step 68, alternate key ranges are generated by the system using a systematic process that performs a lookup against the primary key ranges (e.g., on a state-wide or a nationwide basis) to find a range in which the alternate key fits. This then becomes the alternate key range for that alternate key (one range for each alternate key). The alternate key ranges are stored in an alternate key range database table 70. In step 72, the system resolves entities using the network entity table 66 and the alternate key range table 70. Prior to performing this step, it is noted that the system could perform name “cleansing” (e.g., scrubbing and/or normalization of data), if desired. In step 74, a determination is made as to whether all entities have been resolved. If a negative determination is made, step 72 occurs, wherein further resolution processing occurs. Otherwise, processing ends.

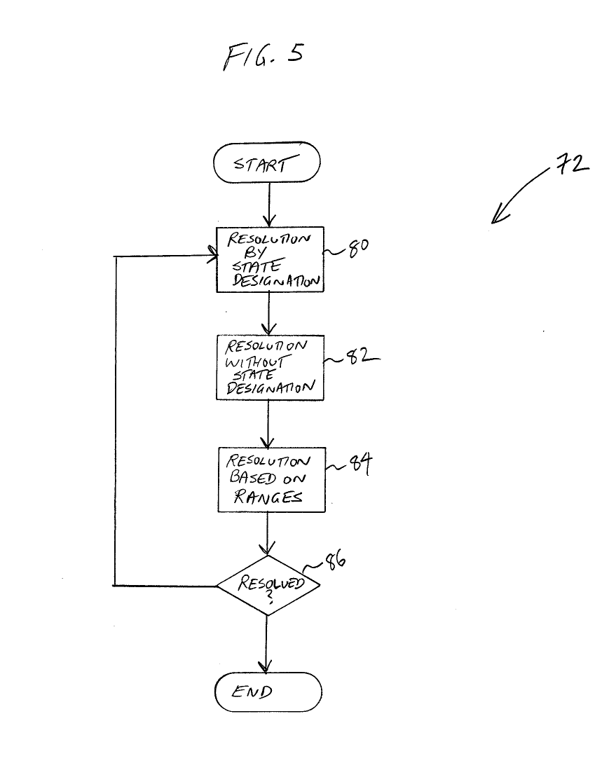

FIG. 5 is a flowchart showing step 72 of FIG. 4 in greater detail. The entity resolution step 72 processes keys to resolve entities using a variety of approaches, including, but not limited to, resolution using keys by state designation, resolution without state designation, and resolution based on ranges. Of course, other types or resolution (e.g., processing keys on a nation-wide basis) could be performed, if desired. Ranges could be provided by one or more suitable third-party data providers, such as, but not limited to, Search Software of America (SSA)/Informatica, Experian (QAS Name Search product), Lexis, IBM, etc. In step 80, the system first resolves entities using state designations. This can be accomplished, for example, by processing name ranges and address ranges, by processing exact names with exact addresses, by processing driver license numbers with Social Security numbers, by processing name ranges with driver license numbers, by processing driver license numbers with dates of birth, by processing medical license and name ranges, by processing address ranges with first names and Social Security numbers, and/or by processing address ranges with first names and driver license numbers. Of course, other types of resolution using state designations are possible.

In step 82, the system resolves entities without use of state designations. This can be accomplished by, for example, processing Social Security numbers with dates of birth, by processing name ranges with Social Security numbers, and/or by processing name ranges with claim numbers. Of course, other types of resolution are possible.

In step 84, the system resolves entities based on ranges. This can be accomplished, for example, by processing alternate name ranges with address ranges, by processing alternate name ranges with exact addresses, by processing alternate name ranges with Social Security numbers, and/or by processing alternate name ranges with driver license numbers. Of course, other types of resolution are possible. In step 90, a determination is made as to whether all claims have been resolved based on ranges. If not, control returns back to step 80; otherwise, processing ends.

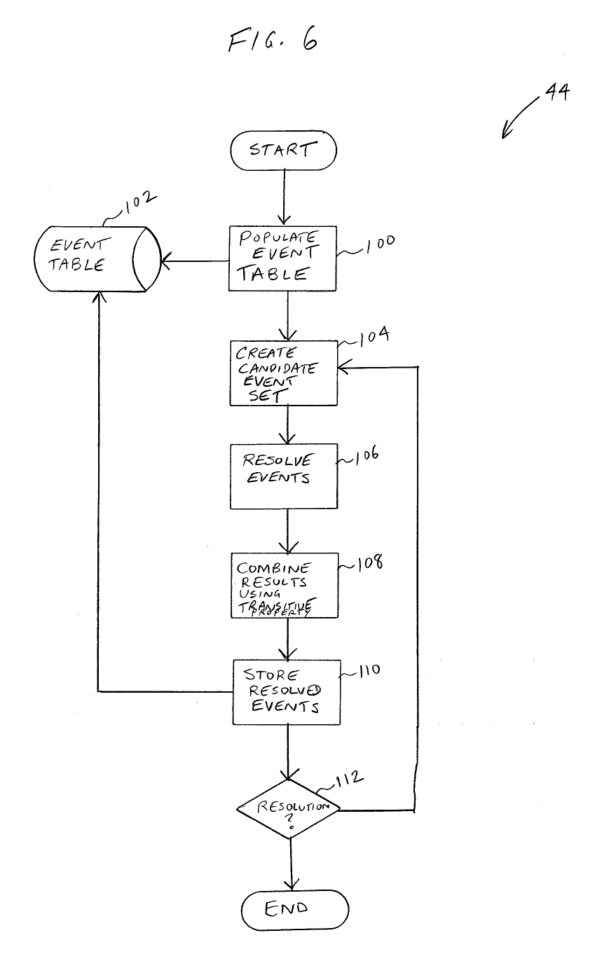

FIG. 6 is a flowchart illustrating additional processing steps carried out by step 44 of FIG. 3. Importantly, in addition to resolving entities (as discussed above in connection with FIGS. 3-5), the system also resolves insurance-related events from raw claims data. In step 100, the system populates an events database table 102 with events obtained from the raw claims data. This data could include scrubbed event data (e.g., event data without any personally-identifiable information) that has been processed by the system and obtained from the raw claims data. In step 104, the system creates a candidate event set for resolution from the event table 102. This could be accomplished by selecting events based on event types and/or by role types. Then, in step 106, the system resolves events using the candidate event set. This could be accomplished, for example, by: grouping events by a carrier main affiliate number, a date of loss (associated with an insurance claim), and/or by an entity identifier; grouping events by carrier main affiliate number, date of loss, location of loss street/city and state; grouping events based on carrier main affiliate number, date of loss, and policy number; and/or by grouping events based on carrier main affiliate number, date of loss and claim number (based on claim pattern cleansing applied during event extraction/cleansing). In step 108, the system combines grouped results using a transitive property, which functions as a “wrapper” that finds all parties in an event to ensure that the reported relationships are maintained. In step 110, the resolved events are stored in the event table 102. In step 112, a determination is made as to whether all events have been resolved. If not, control passes back to step 104; otherwise, processing ends.

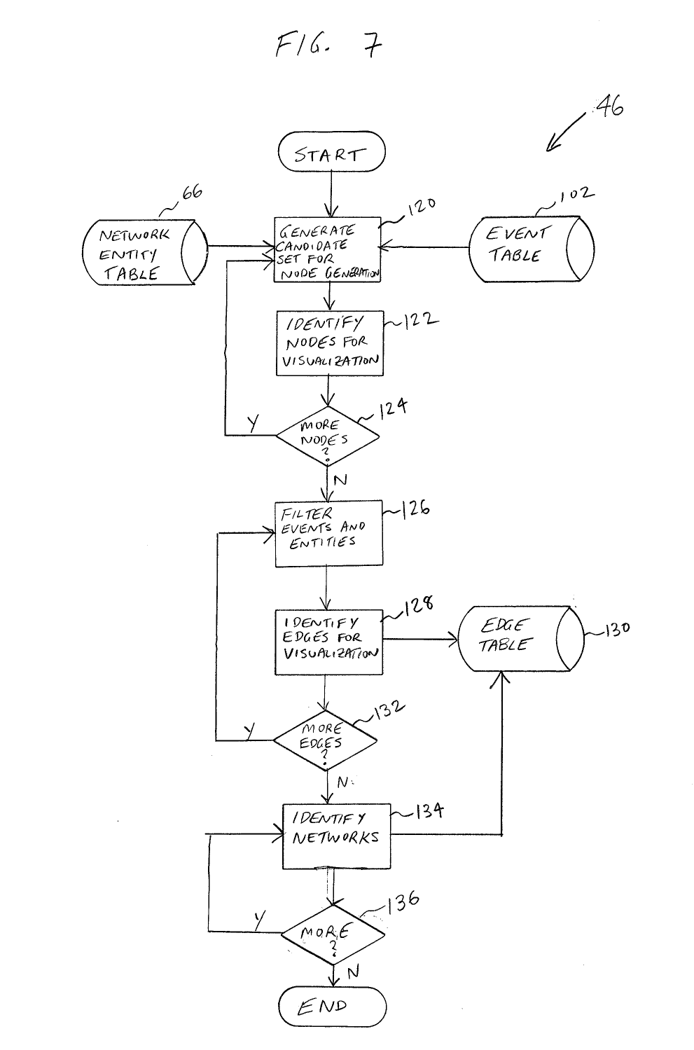

FIG. 7 is a flowchart showing step 46 of FIG. 3 in greater detail. Importantly, step 46 conducts network analysis on the entity and event data in order to detect and indicate relationships between entities and events, using machine learning (artificial intelligence) techniques. In step 120, the system generates a candidate set for generating nodes in a network graph, using the network entity table 66 and the event table 102. Then, in step 122, the system identifies nodes that will be utilized for visualization. Service providers that are identified by the system could be linked to their associated entities. In step 124, a determination is made as to whether more nodes should be identified. If so, control passes back to step 120; otherwise, in step 126, the system filters the events and entities, and in step 128, the system identifies edges between the previously-identified nodes and stores the edges in an edge table 130. In step 132, a determination is made as to whether more edges require processing. If so, control passes back to step 126; otherwise, step 134 occurs. In step 134, the system identifies networks, whereby nodes and edges are grouped into discrete networks. Once the networks are identified, they are stored in the edge table 130. In step 136, a determination is made as to whether additional networks require identification. If so, step 134 is repeated; otherwise, processing ends.

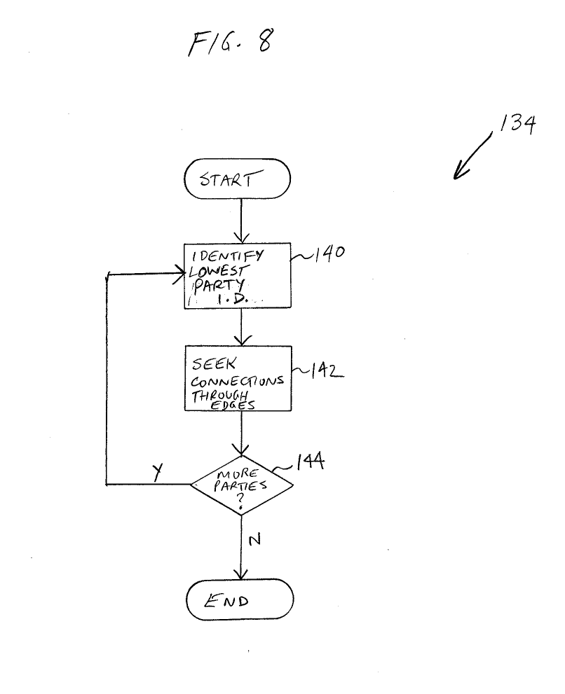

FIG. 8 is a flowchart showing step 134 of FIG. 7 in greater detail. The system automatically identifies networks using machine learning algorithms as follows. First, in step 140, the system looks up the lowest party entity identifier in the candidate set (represented by a node). Then, in step 142, the system seeks all of the node's connections through the edges. The process then continues across the depth of the candidate set, until all connections are found. If, in step 144, more parties must be processed, processing returns back to step 140. The network identifier is designated as the minimum entity identifier of the step. These processes can be repeated for each involved party (entity) associated with an event, until all entities are processed. This machine learning approach automatically improves the system's ability to automatically identify networks and associated nodes and edges, with subsequent use.

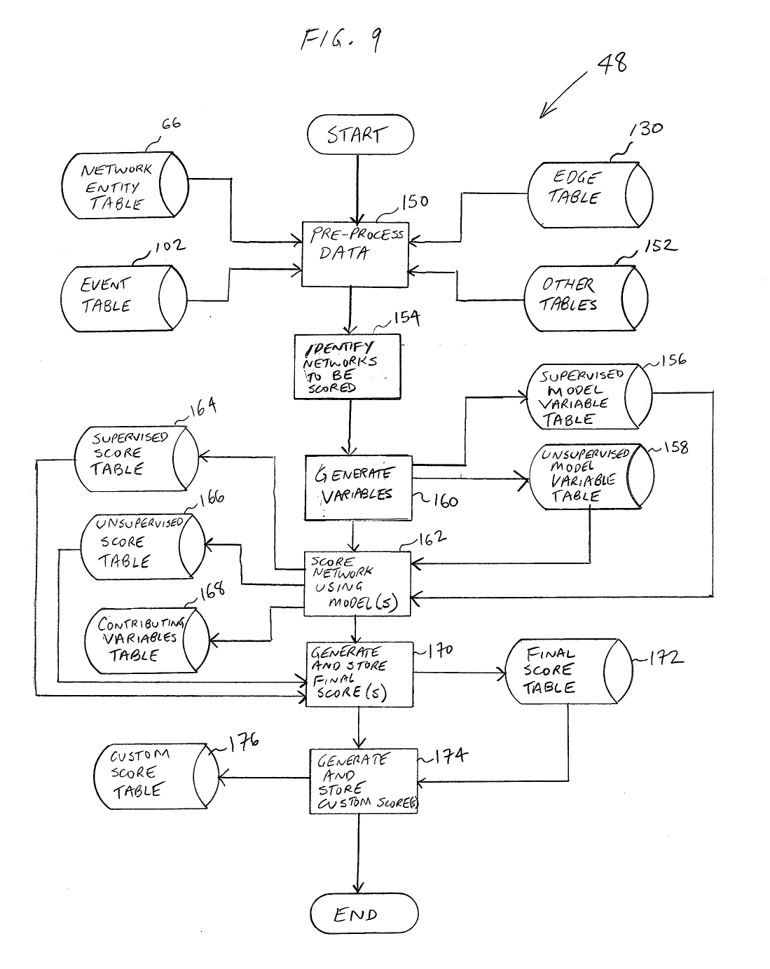

FIG. 9 is a flowchart showing processing step 48 of FIG. 3 in greater detail. In step 150, the system pre-processes data from the network entity table 66, the event table 102, the edge table 130, and other tables 152 (which could include tables containing data extracts, line-of-business (LOB) information, vehicle identifier numbers, injury descriptions, etc.). Such pre-processing involves, for example, the system automatically selecting only networks where there are a pre-defined number of events, populating key tables that will later be used by the system, determining LOB information (e.g., for claims based on loss type, coverage types, etc.), counting event injuries, etc. In step 154, the system automatically determines which model(s) will be used to score a network, as well as generates and populates series of interim tables to calculate and store all variables and corresponding measures. In step 160, the system generates variables that will be used by the system, and stores the variables in a supervised model variable table 156 and an unsupervised model variable table 158. Such variables include graph theory variables, claim-related variables, and variables relating to service providers. Importantly, the values assigned to these values by the scoring models/modules of the system influence the machine learning behavior of the system, as well as automatically improving subsequent machine learning behavior of the system through automatic adjustment of such valuables with future use.

In step 162, the system scores the networks using one or more models, and stores the output in a supervised score table 164, an unsupervised score table 166, and a contributing variables table 168. Each scorable network is preferable analyzed using a supervised model and an unsupervised model, both of which are embodied as machine learning (artificial intelligence) computer algorithms. Specifically, with the supervised model, the system automatically infers an outcome using training data, while with the unsupervised model, the system automatically attempts to find hidden structure/relationships in data. The top contributing variables for the supervised model (e.g., scores that pass a pre-set threshold) are stored in ranked order. For the unsupervised model, the top 50 variables could be ranked in order and stored. The supervised score table 164 includes a network identifier, a supervised model region, and raw and normalized scores for all scorable networks. The unsupervised score table 166 includes a network identifier as well as raw and normalized scores for all scorable networks. The contributing variables table 168 includes all top variables in ranked order for all scorable networks. The supervised score table 164, the unsupervised score table 166, and any interim tables are processed in step 170, and the system generates and stores a final score for the network and stores the final score in a final score table 172. The final score for a scorable network is the higher of the normalized supervised score and the normalized unsupervised score. Data elements such as counts of entities, events, and counts of involved parties and service providers are collected along with model scores and are stored in the table 172, which includes the final score, region, the model which yielded the maximum score, counts of entities and events, counts of involved parties and service provides for each scorable network, etc. Finally, in step 174, the system generates and stores a custom score, if desired, and stores the score in a custom score table 176. The custom score could be determined using any desired parameters. For example, any scorable networks that have a score of 750 or higher could be designated as a network of special interest (NSI), and for each NSI, a custom score could be calculated based on core events for each insurer group that makes up the NSI. The custom score for the NSI could be company-specific, if desired. The custom score table 176 could include company-specific scores for each insurer group for each NSI, if desired. Importantly, with subsequent use, the machine learning components executed by the system (including the supervised and unsupervised models) automatically improve speed and accuracy in identifying and scoring network nodes and edges, thus improving the system's ability to automatically detect and visualize potentially fraudulent activity.

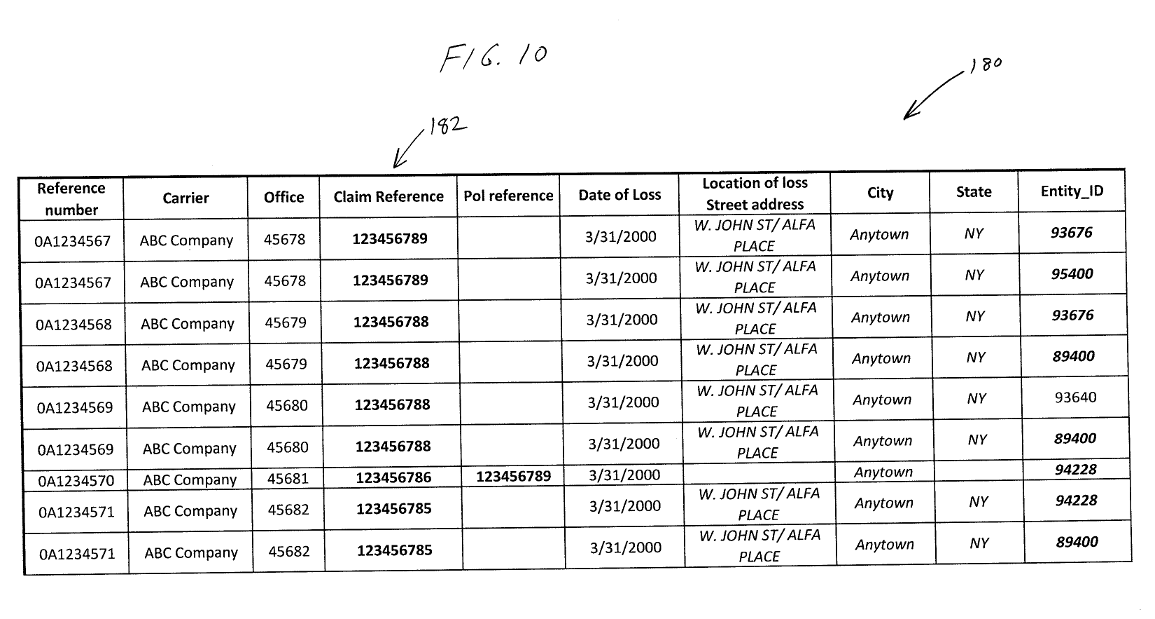

FIG. 10 is a table illustrating event resolution processing carried out by the system. As mentioned above, the system can process raw claims data to resolve entities. Advantageously, this permits the system to compensate for inconsistencies in claim data, including missing data, skewed data, incorrectly formatted data, etc. For example, as shown in FIG. 10, a table 180 of raw claims data could include a column 182 identifying claim references. As can be seen, each entry in the column is not consistent, and there are different claim references. While these references are different, they all relate to the same loss event occurring at the same location, and involving the same carrier. The system can thus compensate for different claim references by resolving them with the same entity.

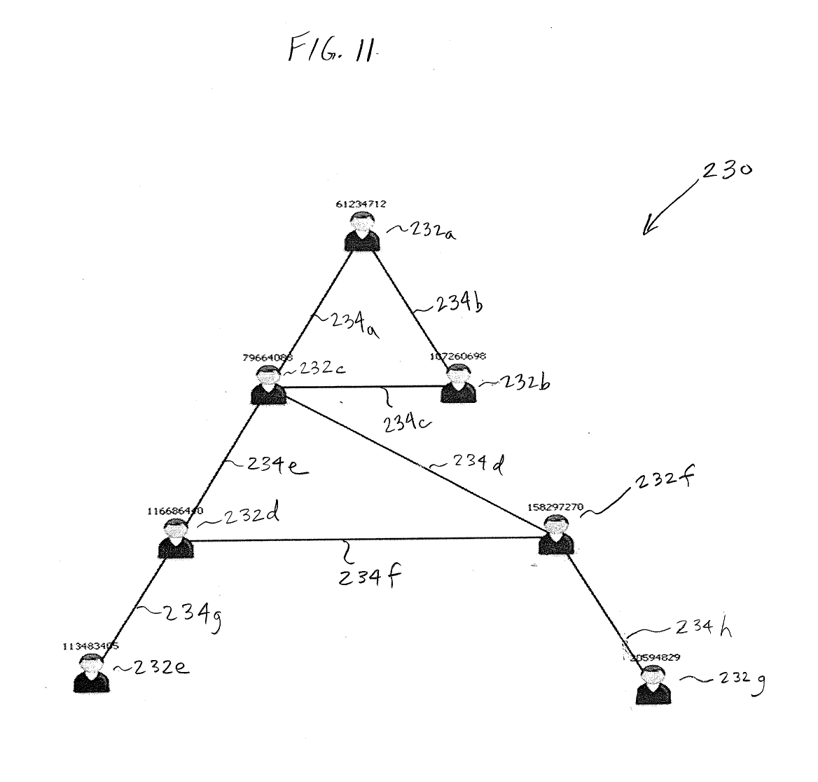

FIG. 11 is a diagram illustrating network analysis performed by the system. Entities could be graphically represented as nodes 232a-232g in a network graph 230, and events linking those entities could be represented as edges 234a-234h. Such a representation allows a user of the system to quickly see relationships between entities and events, and to detect potentially fraudulent activity (e.g., organized fraudulent activity, etc.).

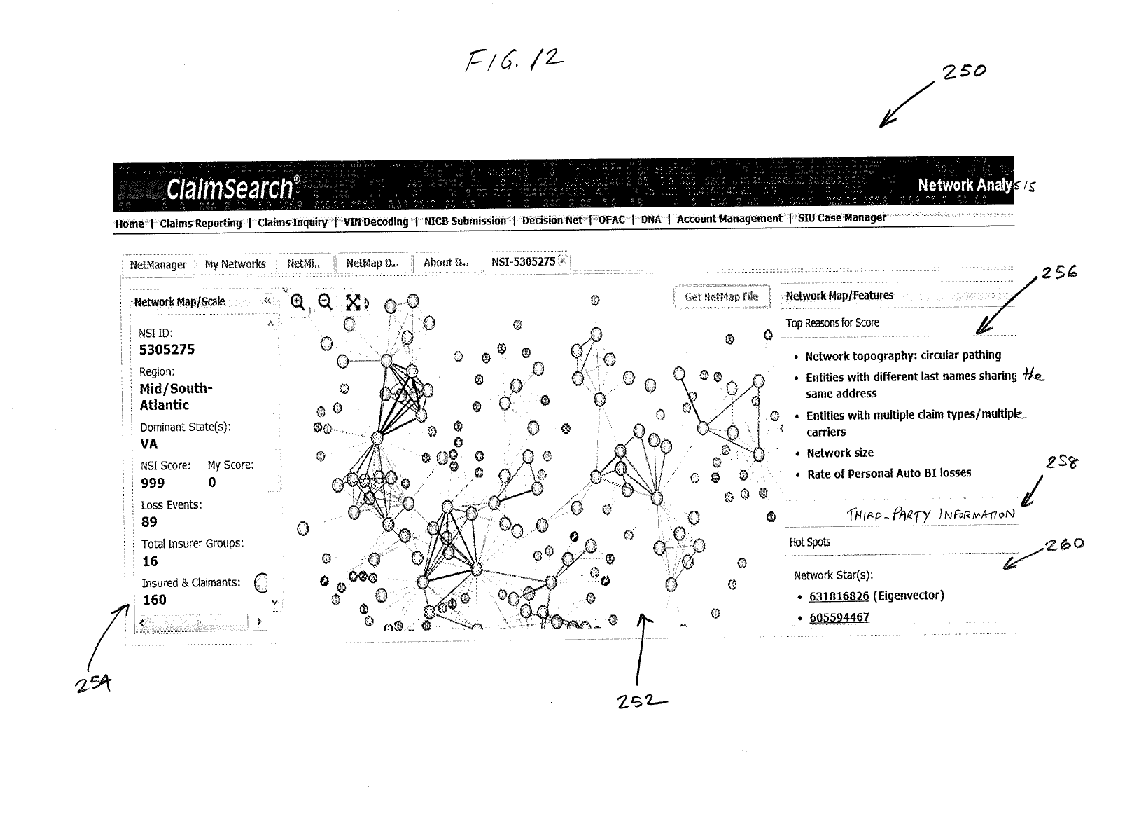

FIGS. 12-13 are screenshots illustrating an interactive graphical user interface 250 generated by the system and displayed on a user's computer system, such as the computer system(s) 20 of FIG. 1. As can be seen, the interface 250 includes an interactive network visualization area 252 that graphically depicts the network and related analysis generated by the system (including networks, entities, links between entities, etc.). A detailed network information region 254 is also provided and lists the network ID, the geographic region covered by the network, the dominant state within the region, the network score, total number of loss events in the network, total insurer groups, number of insured and claimants, and other information. A “reason” pane 256 displays detailed reasons in support of the network score, and an expandable pane 258 allows the user to access permitted third-party information, if desired. Additionally, a “hot spots” pane 260 allows the user to access detailed information about the network. Another pane 270 (see FIG. 13) allows the user to access information about significant entities, such as prominent medical providers, prominent legal providers, etc. Also, as shown in FIG. 13, different icons can be used to indicate different nodes. For example, the icon 272 could represent an individual claimant, while the icon 274 could represent a legal service provider and the icon 276 could represent a healthcare provider. As can be appreciated, the network visualization provided by the system allows a user to visually see relationships between entities and associated events, thereby facilitating detection of insurance-related fraud. By clicking on one of the icons 272-276, the user can access detailed information about the particular entity, as well as information about events (edges) linking that entity to other entities.

It is noted that the network visualizations generated by the system could be further analyzed/interrogated using any desired visualization tools, such as the NETMAP visualization tool. Further, the intelligence developed by the system of the present disclosure (e.g., through the assembly and scoring of the networks) is stored and can be represented or conveyed in a downloadable format which captures key elements of the network (such as the data shown in elements 252-260 of FIG. 12), and the network-embedded set of data which defines the network. Such information could include data relating to events and entities which exist in that data set and which may be reported at a later point in time. Such features allow a user to work with the network visualizations from various perspectives (e.g., an “aerial view” provided by the web and a “ground view” provided in NETMAP). Further, it is noted that the visualization information (and embedded network intelligence) generated by the system could be conveyed digitally using hypertext markup language (HTML) and transported to a separate software-based analytics tool (such as NETMAP), if desired.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected by letters patent is set forth in the appended claims.

What is claimed is:

1. A system for computerized fraud detection using machine learning and network analysis, comprising:
a first computer system in electronic communication with a second computer system via a communications network, the first computer electronically obtaining insurance claims data from the second computer system, wherein:
the first computer system executes a network detection module that processes the insurance claims data received from the second computer system using at least one machine learning algorithm which automatically identifies network nodes, edges, and relationships based on the processed insurance claims data, the identified network nodes, edges, and relationships indicative of potential insurance fraud; and
a third computer system in electronic communication with the first computer system via the communications network, wherein:
the third computer system generates and displays an interactive visualization user interface to a user of the third computer system, the interactive visualization user interface including an interactive graphical representation of the identified network nodes, edges, and relationships indicative of potential insurance fraud.

2. The system of claim 1, further comprising a claims database stored on the first computer system, the claims database locally storing the insurance claims data received from the second computer system.

3. The system of claim 1, wherein the network detection module further comprises a claims data processing module, an entity and event resolution module, a network analysis module, a network scoring module, and a user interface module.

4. The system of claim 3, wherein the claims data processing module electronically receives and processes raw claims data.

5. The system of claim 4, wherein the claims data processing module removes personal information from the raw claims data.

6. The system of claim 5, wherein the claims data processing module formats the raw data into a common data storage format.

7. The system of claim 3, wherein the entity and event resolution module processes output data from the claims processing module to resolve entities and events within the output data.

8. The system of claim 3, wherein the network analysis module processes output from the entity and event resolution module to automatically generate one or more networks linking entities and events identified by the entity and event resolution module, the one or more networks including the nodes, edges, and relationships.

9. The system of claim 3, wherein the network scoring module scores each network generated by the network detection module to provide an indication of a degree of fraud occurring within the network.

10. The system of claim 3, wherein at least one of the network analysis module or the network scoring module executes a supervised machine learning algorithm.

11. The system of claim 3, wherein at least one of the network analysis module or the network scoring module executes an unsupervised machine learning algorithm.

12. The system of claim 3, wherein the user interface module generates the interactive graphical representation of the identified network nodes, edges, and relationships indicative of potential insurance fraud, and transmits the graphical representation to the interactive visualization interface for display to the user.

13. A method for computerized fraud detection using machine learning and network analysis, comprising the steps of:
electronically obtaining insurance claims data at a first computer system from a second computer system in electronic communication with the first computer system via a communication network;
executing a network detection module at the first computer system, the network detection module processing the insurance claims data received from the second computer system using at least one machine learning algorithm which automatically identifies network nodes, edges, and relationships based on the processed insurance claims data, the identified network nodes, edges, and relationships indicative of potential insurance fraud; and
generating and displaying at a third computer system in communication with the first computer system via the communication network an interactive visualization user interface to a user of the third computer system, the interactive visualization user interface including an interactive graphical representation of the identified network nodes, edges, and relationships indicative of potential insurance fraud.

14. The method of claim 1, further comprising storing a claims database on the first computer system, the claims database locally storing the insurance claims data received from the second computer system.

15. The method of claim 1, wherein the step of executing the network detection module further comprises executing a claims data processing module, an entity and event resolution module, a network analysis module, a network scoring module, and a user interface module.

16. The method of claim 15, further comprising electronically receiving and processing raw claims data using the claims data processing module.

17. The method of claim 16, further comprising removing personal information from the raw claims data using the claims data processing module.

18. The method of claim 17, further comprising formatting the raw data into a common data storage format using the claims data processing module.

19. The method of claim 15, further comprising processing output data from the claims processing module to resolve entities and events within the output data using the entity and event resolution module.

20. The method of claim 15, further comprising processing output from the entity and event resolution module using the network analysis module to automatically generate one or more networks linking entities and events identified by the entity and event resolution module, the one or more networks including the nodes, edges, and relationships.

21. The method of claim 15, further comprising scoring each network generated by the network detection module using the network scoring module to provide an indication of a degree of fraud occurring within the network.

22. The method of claim 15, wherein the step of executing the network analysis module or the network scoring module further comprises executing a supervised machine learning algorithm.

23. The method of claim 15, wherein step of executing the network analysis module or the network scoring module further comprises executing an unsupervised machine learning algorithm.

24. The method of claim 15, wherein the step of executing the user interface module further comprises generates the interactive graphical representation of the identified network nodes, edges, and relationships indicative of potential insurance fraud using the user interface module, and transmitting the graphical representation to the interactive visualization interface for display to the user.
